(19) United States
(12) Patent Application Publication
(10) Pub. No.: US 2026/0210902 A1
(43) Pub. Date: Jul. 23, 2026

(54) GAS SENSING CHIP, MANUFACTURING METHOD THEREOF AND GAS SENSING DEVICE

(71) Applicant: NATIONAL TSING HUA UNIVERSITY, HSINCHU (TW)

(72) Inventors: Yu-Lun CHUEH, HSINCHU (TW); Ruei-Hong CYU, HSINCHU (TW); Tzu-Wen KUO, HSINCHU (TW)

(21) Appl. No.: 19/256,197

(22) Filed: Jul. 1, 2025

(30) Foreign Application Priority Data
Jan. 23, 2025 (TW) 114102974

(51) Int. Cl. G01N 27/414; B32B 18/00; B32B 37/02; B32B 37/18

(52) U.S. Cl. CPC G01N 27/4141; B32B 18/00; B32B 37/02; B32B 37/18; B32B 2307/7376; B32B 2309/105; B32B 2310/021; B32B 2310/04; B32B 2457/14

(57) ABSTRACT

A manufacturing method of a gas sensing chip includes the steps as follows. A two-dimensional semiconductor is provided, and a gas selectivity-enhancing compound is coated on a surface of the two-dimensional semiconductor. The gas selectivity-enhancing compound includes at least one of hexagonal boron nitride, zeolitic imidazolate framework and copper phthalocyanine.

### RELATED APPLICATIONS

This application claims priority to Taiwan Application Serial Number 114102974, filed Jan. 23, 2025, which is herein incorporated by reference.

### BACKGROUND

### Technical Field

The present disclosure relates to a gas sensing chip, a manufacturing method thereof and a gas sensing device. More particularly, the present disclosure relates to a gas sensing chip, a manufacturing method thereof and a gas sensing device which can improve the sensitivity, selectivity and stability of gas sensing.

### Description of Related Art

With the rapid development of Internet of things technology, the application of miniaturized sensors has become wider. Especially in the issues related to environmental safety, indoor air quality and gas leakage, the demand for gas sensors has significantly increased. There are three main types of gas sensors, which are catalytic combustion sensors, electrochemical sensors and solid-state semiconductor sensors.

Catalytic combustion sensors detect the resistance change of gases by burning the gases using a catalyst and a heating element. Therefore, catalytic combustion sensors can only detect flammable gases, are not sensitive enough to gases with low concentration, and have poor gas selectivity. Electrochemical sensors detect gas concentration through electrochemical reactions between electrolytes and gases. However, the stability and service life thereof are poor, and calibrations are frequently required. Solid-state semiconductor sensors use metal oxides as sensing materials. The selectivity and long-term stability thereof are poor, the manufacturing cost thereof is high and high operating temperature is required, which limits the applications of solid-state semiconductor sensors in the electronic products.

In this regard, how to improve the selectivity and stability of gas sensors, or reduce the operational limitations thereof, has become a goal for the relevant industries.

### SUMMARY

According to one aspect of the present disclosure, a manufacturing method of a gas sensing chip includes the steps as follows. A two-dimensional semiconductor is provided. A gas selectivity-enhancing compound is coated on a surface of the two-dimensional semiconductor. The gas selectivity-enhancing compound includes at least one of hexagonal boron nitride, zeolitic imidazolate framework and copper phthalocyanine.

According to another aspect of the present disclosure, a gas sensing chip includes a two-dimensional semiconductor thin film and a gas selectivity-enhancing compound layer. The gas selectivity-enhancing compound layer is disposed on a surface of the two-dimensional semiconductor thin film. A material of the gas selectivity-enhancing compound layer includes at least one of hexagonal boron nitride, zeolitic imidazolate framework and copper phthalocyanine.

According to one another aspect of the present disclosure, a gas sensing device includes a gas sensing chip of the aforementioned aspect, a sensing chamber and a signal processing unit. The sensing chamber has a compartment and an air inlet, wherein the compartment is in communication with outside through the air inlet, and the gas sensing chip is located in the compartment. The signal processing unit is electrically connected to the gas sensing chip.

### BRIEF DESCRIPTION OF THE DRAWINGS

The present disclosure can be more fully understood by reading the following detailed description of the embodiment, with reference made to the accompanying drawings as follows:

FIG. 1 is a step flowchart of a manufacturing method of a gas sensing chip according to one embodiment of the present disclosure.

FIG. 2 is a three-dimensional schematic view of a gas sensing chip according to another embodiment of the present disclosure.

FIG. 3A is a three-dimensional schematic view of a gas sensing device according to one another embodiment of the present disclosure.

FIG. 3B is a partial-enlarged schematic view of a sensing module in FIG. 3A.

FIG. 4 is a transmission electron microscope image of the gas sensing chip of the 1st example.

FIG. 5 is a Raman spectrum of the gas selectivity-enhancing compound layer of hexagonal boron nitride in the gas sensing chip of the 1st example.

FIG. 6A is one comparison chart of the response to different gases of the gas sensing chip of the 1st comparative example.

FIG. 6B is a comparison chart of the response to different gases of the gas sensing chip of the 1st example.

FIG. 7 is a diagram of change in the long-term response of the gas sensing chips of the 1st comparative example and the 1st example.

FIG. 8A is a low-magnification microscope image of the gas sensing chip of the 2nd example.

FIG. 8B is a high-magnification microscope image of the gas sensing chip of the 2nd example.

FIG. 9A is another comparison chart of the response to different gases of the gas sensing chip of the 1st comparative example.

FIG. 9B is a comparison chart of the response to different gases of the gas sensing chip of the 2nd example.

FIG. 10 is a diagram of change in the long-term response of the gas sensing chips of the 1st comparative example and the 2nd example.

FIG. 11 is a scanning electron microscope image of the gas sensing chip of the 3rd example.

FIG. 12 is a Raman spectrum of the gas selectivity-enhancing compound layer and copper phthalocyanine in the gas sensing chips of the 3rd example to the 5th example and the 2nd comparative example.

FIG. 13A is a comparison chart of the response to formaldehyde of the gas sensing chips of the 4th example and the 2nd comparative example to the 5th comparative example.

FIG. 13B is a comparison chart of the response to ethanol of the gas sensing chips of the 4th example and the 2nd comparative example to the 5th comparative example.

FIG. 13C is a comparison chart of the response to acetone of the gas sensing chips of the 4th example and the 2nd comparative example to the 5th comparative example.

FIG. 14 is a comparison chart of the response to formaldehyde, ethanol and acetone of the gas sensing chips of the 4th example and the 2nd comparative example to the 5th comparative example.

FIG. 15A is a comparison chart of the response to different gases of the gas sensing chip of the 6th comparative example.

FIG. 15B is a comparison chart of the response to different gases of the gas sensing chip of the 6th example.

### DETAILED DESCRIPTION

The present disclosure will be further exemplified by the following specific embodiments. However, the embodiments can be applied to various inventive concepts and can be embodied in various specific ranges. The specific embodiments are only for the purposes of description, and are not limited to these practical details thereof. Furthermore, in order to simplify the drawings, some conventional structures and elements will be illustrated in the drawings by a simple and schematic way.

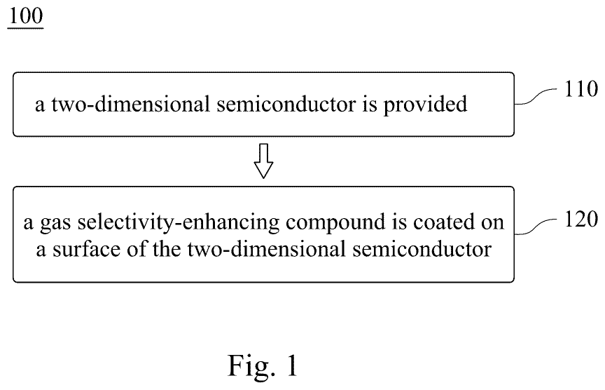

Referring to FIG. 1, FIG. 1 is a step flowchart of a manufacturing method of a gas sensing chip 100 according to one embodiment of the present disclosure. The manufacturing method of the gas sensing chip 100 includes Step 110 and Step 120.

Specifically, Step 110 is to provide a two-dimensional semiconductor. The two-dimensional semiconductor can include at least one of platinum diselenide, tin diselenide and molybdenum disulfide. The two-dimensional semiconductor can be a thin film, and a thickness of the thin film can range from 1 nm to 10 nm. The two-dimensional semiconductor can be prepared by a low-temperature plasma-assisted selenization technique, in which plasma is used for exciting the reactant molecules into a plasma state to be deposited on a substrate. Therefore, the two-dimensional semiconductor can be grown on various substrates to form two-dimensional semiconductor thin films with different sizes, which is suitable for different application conditions.

Furthermore, a horizontal tube furnace or a vertical tube furnace can be used to prepare the two-dimensional semiconductor, wherein the vertical tube furnace can enhance the effect of plasma. By adjusting the plasma power, defects can be effectively reduced or the reaction can be effectively controlled. Therefore, the selenization reaction can be completed under a condition with the temperature (below 400° C.) much lower than the reaction temperature thereof. The two-dimensional semiconductor with high uniformity can be obtained, and the gas selectivity, stability and responsiveness of the two-dimensional semiconductor can be simultaneously improved.

Moreover, the thin film can be formed by stacking a plurality of structural layers, and a thickness of each of the plurality of structural layers can range from 0.1 nm to 1.0 nm.

Step 120 is to coat a gas selectivity-enhancing compound on a surface of the two-dimensional semiconductor. A thickness of the gas selectivity-enhancing compound on the surface of the two-dimensional semiconductor can range from 0.1 nm to 1.0 nm. Therefore, by coating the gas selectivity-enhancing compound on the two-dimensional semiconductor, the gas selectivity and long-term stability of the two-dimensional semiconductor can be effectively enhanced, and the sensing lifespan of the two-dimensional semiconductor can be extended and the frequency of calibration thereof can be reduced.

The gas selectivity-enhancing compound includes at least one of hexagonal boron nitride (h-BN), zeolitic imidazolate framework (ZIF) and copper phthalocyanine (CuPc). The characteristics and coating methods of the aforementioned materials will be described in the following paragraphs.

The hexagonal boron nitride is composed of boron atoms and nitrogen atoms arranged in a hexagonal honeycomb structure, and can serve as an insulator in two-dimensional materials. The hexagonal boron nitride has great thermal stability and chemical stability, so the gas selectivity and stability of the two-dimensional semiconductor can be effectively enhanced. The hexagonal boron nitride can be synthesized through chemical vapor deposition (CVD) by using ammonia borane as a precursor. The growth temperature thereof can range from 1000° C. to 1100° C., and the heating temperature of the precursor can range from 65° C. to 85° C. The growth gas can be a mixture of argon and hydrogen with a ratio of 1:5 to 1:15, and the growth time can range from 0.5 hours to 2 hours.

The hexagonal boron nitride can be coated on the surface of the two-dimensional semiconductor by bubbling transfer process, dry transfer process using thermal release tape or wet etching transfer process.

In the bubbling transfer process, the hexagonal boron nitride can be coated on the surface of the two-dimensional semiconductor by the following steps. First, a substrate is provided, wherein the hexagonal boron nitride and a polymer are formed on a surface of the substrate. The substrate is electrically connected to a cathode of a water electrolysis device, and a current is applied to the water electrolysis device, so as to make the hexagonal boron nitride and the polymer detach from the substrate to form a hexagonal boron nitride film. Then, the hexagonal boron nitride film is transferred to the surface of the two-dimensional semiconductor. Finally, the polymer is removed from the hexagonal boron nitride film by a solvent. Therefore, hydrogen and hydroxyl groups will be generated at the cathode of the water electrolysis device, so as to make the hexagonal boron nitride and the polymer detach from the substrate and transfer to the target two-dimensional semiconductor.

In the dry transfer process using thermal release tape, the hexagonal boron nitride can be coated on the surface of the two-dimensional semiconductor by the following steps. First, a substrate is provided, wherein the hexagonal boron nitride and a polymer are formed on a surface of the substrate. A tape is used to detach the hexagonal boron nitride and the polymer from the substrate to form a hexagonal boron nitride film. Then, the hexagonal boron nitride film is transferred to the surface of the two-dimensional semiconductor, and the tape is removed. Finally, the polymer is removed from the hexagonal boron nitride film by a solvent. The adhesive in the tape can be thermally releasable, so the tape can be detached by heating to remove the adhesion after transferring.

In the wet etching transfer process, the hexagonal boron nitride can be coated on the surface of the two-dimensional semiconductor by the following steps. First, a substrate is provided, wherein the hexagonal boron nitride and a polymer are formed on a surface of the substrate. The substrate is removed by an etching method to form a hexagonal boron nitride film, wherein the hexagonal boron nitride film includes the hexagonal boron nitride and the polymer. Then, the hexagonal boron nitride film is transferred to the surface of the two-dimensional semiconductor. Finally, the polymer is removed from the hexagonal boron nitride film by a solvent.

The substrate in the aforementioned bubbling transfer process, dry transfer process using thermal release tape or wet etching transfer process can be a copper foil substrate. Therefore, in the wet etching transfer process, iron chloride or ammonium persulfate can be used to remove the copper foil substrate. The polymer can include at least one of poly(methyl methacrylate) (PMMA), polycarbonate (PC) and polypropylene carbonate (PPC). Poly(methyl methacrylate) and polycarbonate can be removed by acetone, and polypropylene carbonate can be removed by methyl phenyl ether. However, the present disclosure is not limited to the aforementioned solvents.

The zeolitic imidazolate framework can be zeolitic imidazolate framework-67 (ZIF-67), which can be obtained from the reaction by mixing cobalt nitrate hexahydrate, 2-methylimidazole and triethylamine (TEA) in deionized water. The zeolitic imidazolate framework can be covered on the surface of the two-dimensional semiconductor by a coating method.

The copper phthalocyanine can be coated on the surface of the two-dimensional semiconductor by the following steps. First, a copper phthalocyanine solution is provided, which includes the copper phthalocyanine and a solvent. A weight ratio of the copper phthalocyanine in the copper phthalocyanine solution can range from 1% to 10%. Then, the copper phthalocyanine solution is coated on the surface of the two-dimensional semiconductor by a drop-casting method. Finally, the solvent is removed from the copper phthalocyanine solution.

Through the aforementioned coating steps, the gas selectivity-enhancing compound can be coated without affecting the structure of the two-dimensional semiconductor. Therefore, the damage or destruction to the structure of the two-dimensional semiconductor can be prevented while the gas selectivity of the two-dimensional semiconductor is enhanced, which is favorable for maintaining the performance of the two-dimensional semiconductor.

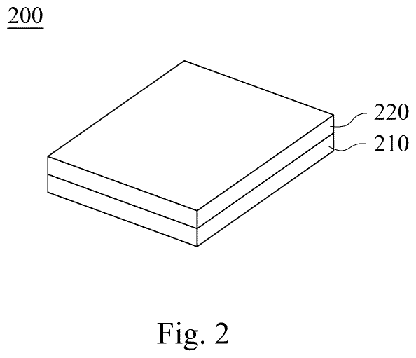

Referring to FIG. 2, FIG. 2 is a three-dimensional schematic view of a gas sensing chip 200 according to another embodiment of the present disclosure. The gas sensing chip 200 includes a two-dimensional semiconductor thin film 210 and a gas selectivity-enhancing compound layer 220. The gas selectivity-enhancing compound layer 220 is disposed on a surface of the two-dimensional semiconductor thin film 210.

Specifically, a material of the two-dimensional semiconductor thin film 210 can include at least one of platinum diselenide, tin diselenide and molybdenum disulfide. A thickness of the two-dimensional semiconductor thin film 210 can range from 1 nm to 10 nm. The two-dimensional semiconductor thin film 210 can be formed by stacking a plurality of structural layers (not shown), and a thickness of each of the plurality of structural layers can range from 0.1 nm to 1.0 nm. A material of the gas selectivity-enhancing compound layer 220 includes at least one of hexagonal boron nitride, zeolitic imidazolate framework and copper phthalocyanine. A thickness of the gas selectivity-enhancing compound layer 220 can range from 0.1 nm to 1.0 nm. Other details of the two-dimensional semiconductor thin film 210 and the gas selectivity-enhancing compound layer 220 are the same as or similar to those of the aforementioned two-dimensional semiconductor and the gas selectivity-enhancing compound, and the details will not be given again here.

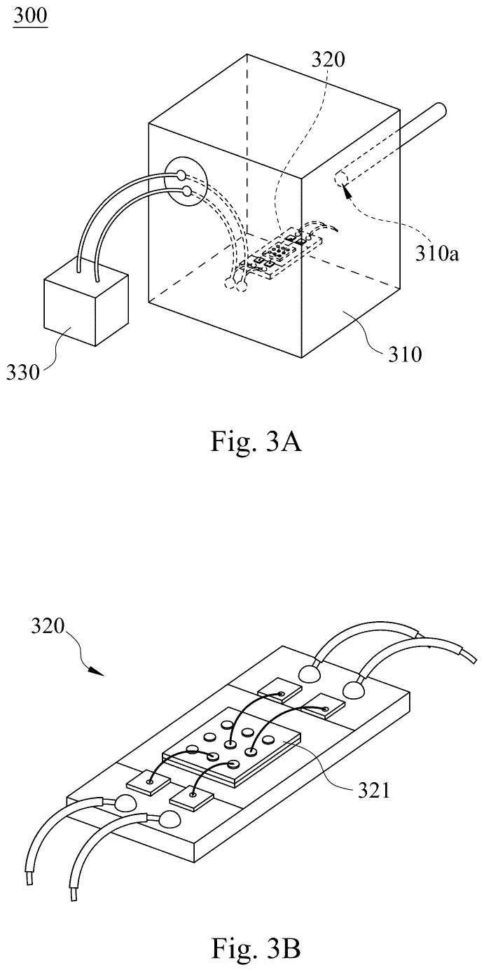

Referring to FIG. 3A and FIG. 3B, FIG. 3A is a three-dimensional schematic view of a gas sensing device 300 according to one another embodiment of the present disclosure, and FIG. 3B is a partial-enlarged schematic view of a sensing module 320 in FIG. 3A. The gas sensing device 300 includes the aforementioned gas sensing chip 321, a sensing chamber 310 and a signal processing unit 330. The gas sensing chip 321 is located in the sensing chamber 310, and the signal processing unit 330 is electrically connected to the gas sensing chip 321.

Specifically, the gas sensing device 300 can further include the sensing module 320, and the gas sensing chip 321 can be disposed on a carrier substrate (the number is omitted) of the sensing module 320. Therefore, the gas sensing chip 321 can be electrically connected to other components by wiring on the carrier substrate to transmit the gas sensing signal.

The sensing chamber 310 has a compartment (the number is omitted) and an air inlet 310a. The compartment is in communication with outside through the air inlet 310a, and the gas sensing chip 321 is located in the compartment. By arranging the sensing chamber 310, the gas sensing chip 321 can be more comprehensively exposed to the gas to-be-tested, and the sensing accuracy and responsiveness can be improved.

The signal processing unit 330 can apply a current to the gas sensing chip 321 and detect the current signal after the gas sensing chip 321 contacts the gas to-be-tested. The sensitivity and selectivity of the gas sensing chip 321 to different gases can be determined by calculating the change of the current, which is applicable to detection of different types of gases.

The present disclosure will be further exemplified by the following specific embodiments so as to facilitate utilizing and practicing the present disclosure completely by the people skilled in the art without over-interpreting and over-experimenting. However, the readers should understand that the present disclosure should not be limited to these practical details thereof, that is, these practical details are used to describe how to implement the materials and methods of the present disclosure and are not necessary.

### 1st Example

The gas sensing chip of the 1st example includes a two-dimensional semiconductor thin film and a gas selectivity-enhancing compound layer. The gas selectivity-enhancing compound layer is disposed on a surface of the two-dimensional semiconductor thin film. The material of the two-dimensional semiconductor thin film includes platinum diselenide, and the material of the gas selectivity-enhancing compound layer includes hexagonal boron nitride.

### 2nd Example

The gas sensing chip of the 2nd example includes a two-dimensional semiconductor thin film and a gas selectivity-enhancing compound layer. The gas selectivity-enhancing compound layer is disposed on a surface of the two-dimensional semiconductor thin film. The material of the two-dimensional semiconductor thin film includes platinum diselenide, and the material of the gas selectivity-enhancing compound layer includes zeolitic imidazolate framework-67.

### 3rd Example

The gas sensing chip of the 3rd example includes a two-dimensional semiconductor thin film and a gas selectivity-enhancing compound layer. The gas selectivity-enhancing compound layer is disposed on a surface of the two-dimensional semiconductor thin film. The material of the two-dimensional semiconductor thin film includes tin diselenide, and the material of the gas selectivity-enhancing compound layer includes copper phthalocyanine. The copper phthalocyanine can be coated on the surface of the two-dimensional semiconductor thin film by the aforementioned drop-casting method. In a copper phthalocyanine solution used in the drop-casting method, a weight ratio of the copper phthalocyanine in the copper phthalocyanine solution can be 1%.

### 4th Example

The gas sensing chip of the 4th example includes a two-dimensional semiconductor thin film and a gas selectivity-enhancing compound layer. The gas selectivity-enhancing compound layer is disposed on a surface of the two-dimensional semiconductor thin film. The material of the two-dimensional semiconductor thin film includes tin diselenide, and the material of the gas selectivity-enhancing compound layer includes copper phthalocyanine. The copper phthalocyanine can be coated on the surface of the two-dimensional semiconductor thin film by the aforementioned drop-casting method. In a copper phthalocyanine solution used in the drop-casting method, a weight ratio of the copper phthalocyanine in the copper phthalocyanine solution can be 5%.

### 5th Example

The gas sensing chip of the 5th example includes a two-dimensional semiconductor thin film and a gas selectivity-enhancing compound layer. The gas selectivity-enhancing compound layer is disposed on a surface of the two-dimensional semiconductor thin film. The material of the two-dimensional semiconductor thin film includes tin diselenide, and the material of the gas selectivity-enhancing compound layer includes copper phthalocyanine. The copper phthalocyanine can be coated on the surface of the two-dimensional semiconductor thin film by the aforementioned drop-casting method. In a copper phthalocyanine solution used in the drop-casting method, a weight ratio of the copper phthalocyanine in the copper phthalocyanine solution can be 10%.

### 6th Example

The gas sensing chip of the 6th example includes a two-dimensional semiconductor thin film and a gas selectivity-enhancing compound layer. The gas selectivity-enhancing compound layer is disposed on a surface of the two-dimensional semiconductor thin film. The material of the two-dimensional semiconductor thin film includes molybdenum disulfide, and the material of the gas selectivity-enhancing compound layer includes hexagonal boron nitride.

### 1st Comparative Example

The gas sensing chip of the 1st comparative example includes a two-dimensional semiconductor thin film, wherein the two-dimensional semiconductor thin film is made of platinum diselenide.

### 2nd Comparative Example

The gas sensing chip of the 2nd comparative example includes a two-dimensional semiconductor thin film, wherein the two-dimensional semiconductor thin film is made of tin diselenide.

### 3rd Comparative Example

The gas sensing chip of the 3rd comparative example includes a two-dimensional semiconductor thin film and a compound layer. The compound layer is disposed on a surface of the two-dimensional semiconductor thin film, wherein the two-dimensional semiconductor thin film is made of tin diselenide, and the material of the compound layer includes 11-mercaptoundecanoic acid (MUA).

### 4th Comparative Example

The gas sensing chip of the 4th comparative example includes a two-dimensional semiconductor thin film and a compound layer. The compound layer is disposed on a surface of the two-dimensional semiconductor thin film, wherein the two-dimensional semiconductor thin film is made of tin diselenide, and the material of the compound layer includes cysteamine (CA).

### 5th Comparative Example

The gas sensing chip of the 5th comparative example includes a two-dimensional semiconductor thin film and a compound layer. The compound layer is disposed on a surface of the two-dimensional semiconductor thin film, wherein the two-dimensional semiconductor thin film is made of tin diselenide, and the material of the compound layer includes phthalocyanine.

### 6th Comparative Example

The gas sensing chip of the 6th comparative example includes a two-dimensional semiconductor thin film, wherein the two-dimensional semiconductor thin film is made of molybdenum disulfide.

In the following paragraphs, the structural determination and gas responsiveness tests for the gas sensing chips of the aforementioned examples and comparative examples will be performed.

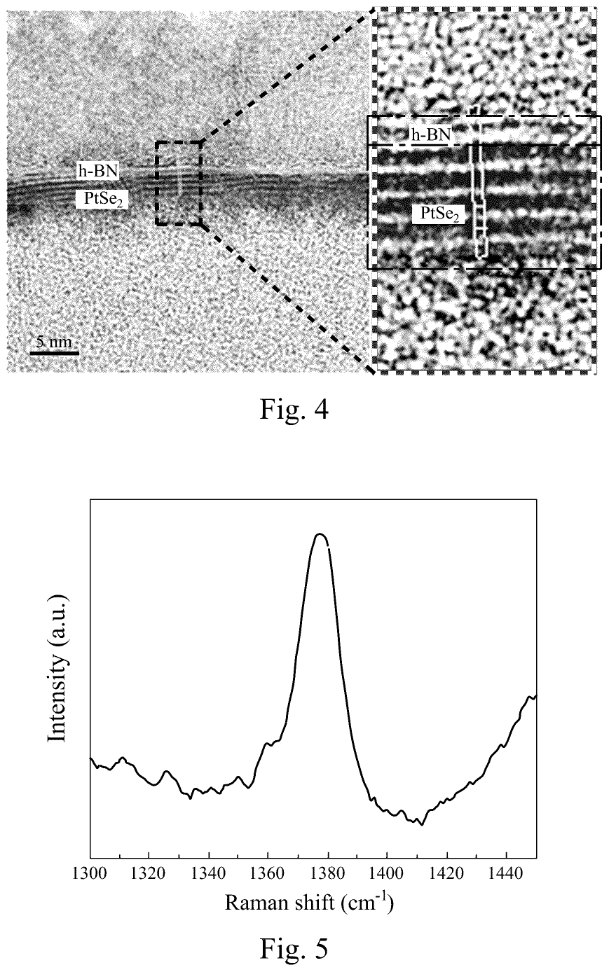

Referring to FIG. 4 and FIG. 5, FIG. 4 is a transmission electron microscope image of the gas sensing chip of the 1st example, and FIG. 5 is a Raman spectrum of the gas selectivity-enhancing compound layer of hexagonal boron nitride in the gas sensing chip of the 1st example. From FIG. 4, it can be understood that in the gas sensing chip of the 1st example, the two-dimensional semiconductor thin film is formed by stacking a plurality of structural layers. The thickness of each of the plurality of structural layers is approximately 0.5 nm to 0.7 nm. The gas selectivity-enhancing compound layer is disposed on the surface of the two-dimensional semiconductor thin film, and the thickness of the gas selectivity-enhancing compound layer is approximately 0.3 nm to 0.4 nm. From FIG. 5, it can be understood that the gas selectivity-enhancing compound layer of the 1st example has a monolayer structure. It should be mentioned that, the present disclosure is not limited to the structural thickness or the number of layers of the 1st example.

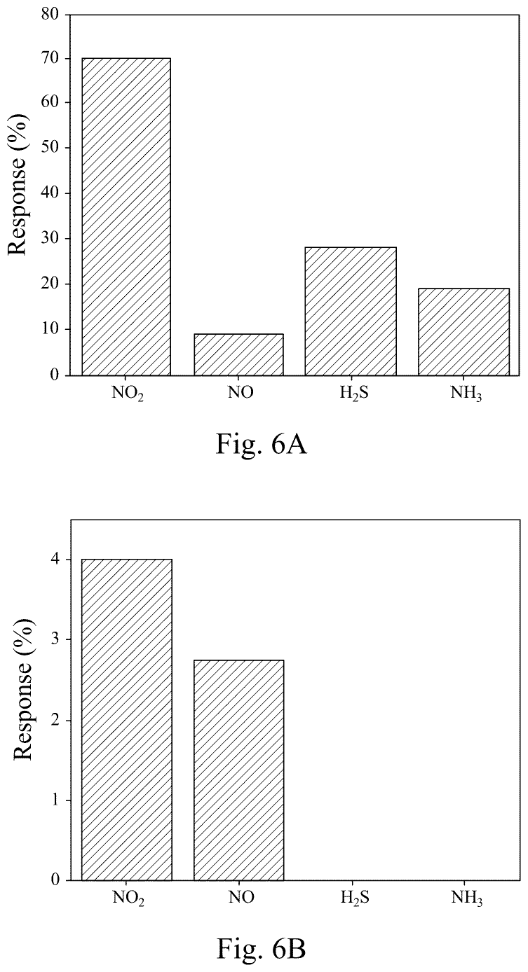

Referring to FIG. 6A and FIG. 6B, FIG. 6A is one comparison chart of the response to different gases of the gas sensing chip of the 1st comparative example, and FIG. 6B is a comparison chart of the response to different gases of the gas sensing chip of the 1st example. From FIG. 6A, it can be understood that the gas sensing chip of the 1st comparative example generates significant responses to nitrogen dioxide (NO₂), nitrogen oxide (NO), hydrogen sulfide (H₂S) and ammonia (NH₃), so it is difficult to distinguish between the detection results of the four gases. From FIG. 6B, it can be understood that due to the arrangement of the gas selectivity-enhancing compound layer including hexagonal boron nitride in the gas sensing chip of the 1st example, only nitrogen dioxide and nitrogen oxide can be adsorbed on the surface of the gas selectivity-enhancing compound layer among the aforementioned four gases. Therefore, the signals from hydrogen sulfide and ammonia can be effectively reduced, and the responsiveness of the gas sensing chip to hydrogen sulfide and ammonia can be significantly suppressed.

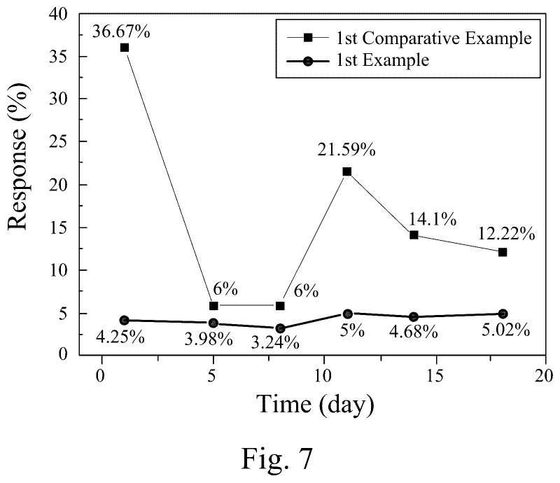

Referring to FIG. 7, FIG. 7 is a diagram of change in the long-term response of the gas sensing chips of the 1st comparative example and the 1st example. From FIG. 7, it can be understood that the response of the gas sensing chip of the 1st comparative example significantly changes over time. The gas sensing chip of the 1st example includes the gas selectivity-enhancing compound layer with hexagonal boron nitride, which has physical and chemical stabilities, and the long-term detection results of the gas sensing chip of the 1st example maintain stable, which is favorable for extending the lifespan of the gas sensing chip and reducing the frequency of calibration.

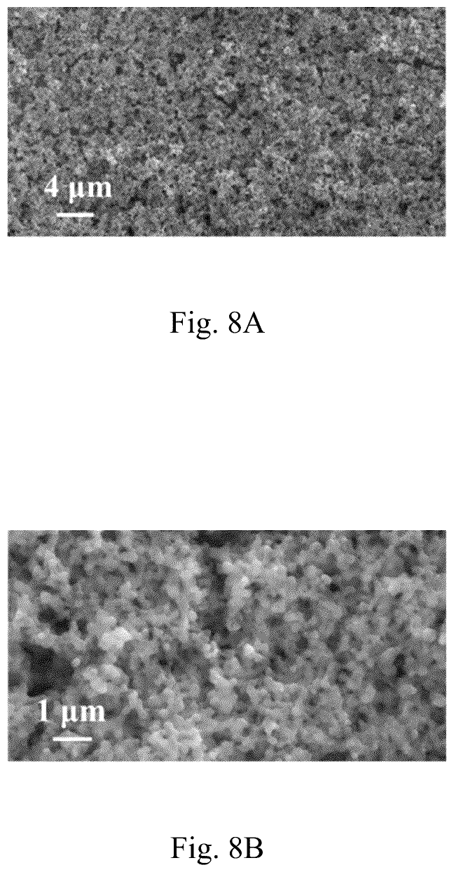

Referring to FIG. 8A and FIG. 8B, FIG. 8A is a low-magnification microscope image of the gas sensing chip of the 2nd example, and FIG. 8B is a high-magnification microscope image of the gas sensing chip of the 2nd example. From FIG. 8A and FIG. 8B, it can be understood that the gas selectivity-enhancing compound layer of the gas sensing chip of the 2nd example is uniformly disposed on the surface of the two-dimensional semiconductor thin film.

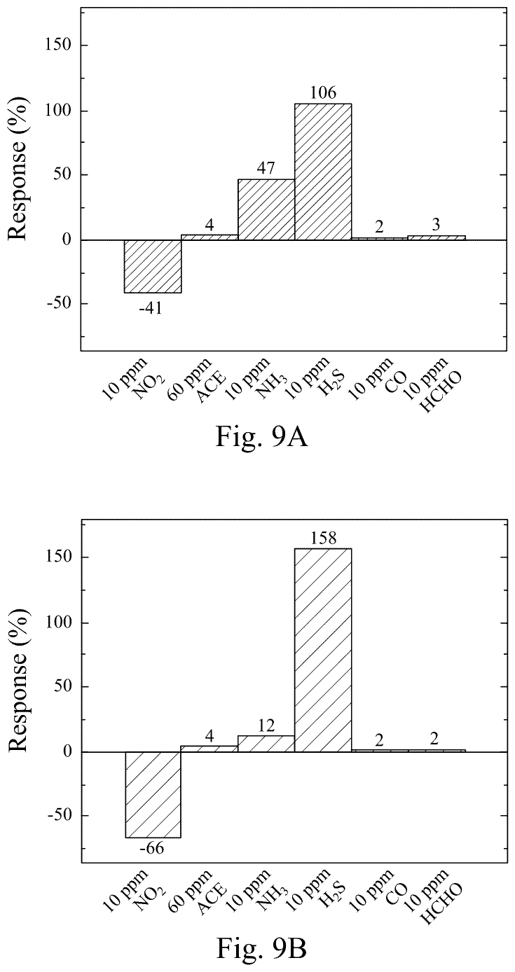

Referring to FIG. 9A and FIG. 9B, FIG. 9A is another comparison chart of the response to different gases of the gas sensing chip of the 1st comparative example, and FIG. 9B is a comparison chart of the response to different gases of the gas sensing chip of the 2nd example. From FIG. 9A, it can be understood that the response differences of the gas sensing chip of the 1st comparative example to nitrogen dioxide, hydrogen sulfide and ammonia are slight. From FIG. 9B, it can be understood that the gas sensing chip of the 2nd example includes the gas selectivity-enhancing compound layer with zeolitic imidazolate framework-67, the response to ammonia is suppressed, and the response to hydrogen sulfide and nitrogen dioxide can be simultaneously and effectively enhanced and the low responses to acetone (ACE), carbon monoxide (CO) and formaldehyde (HCHO) can be maintained.

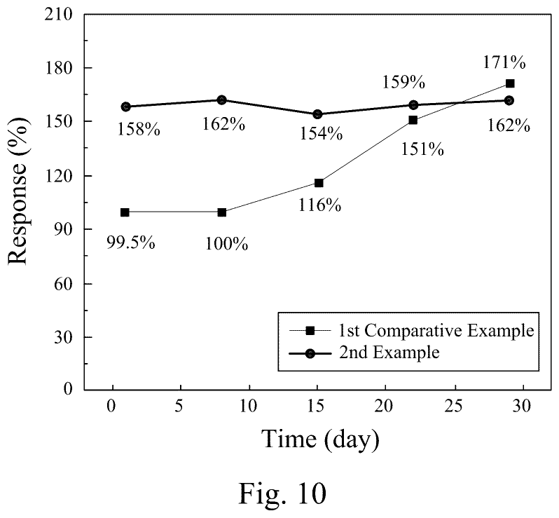

Referring to FIG. 10, FIG. 10 is a diagram of change in the long-term response of the gas sensing chips of the 1st comparative example and the 2nd example. From FIG. 10, it can be understood that the gas selectivity-enhancing compound layer can be coated on the surface of the two-dimensional semiconductor thin film by a coating method, the structure of the two-dimensional semiconductor thin film is not damaged or modified. Therefore, detection results can maintain stable over a long period of time, which is favorable for improving the lifespan and stability of the gas sensing chip.

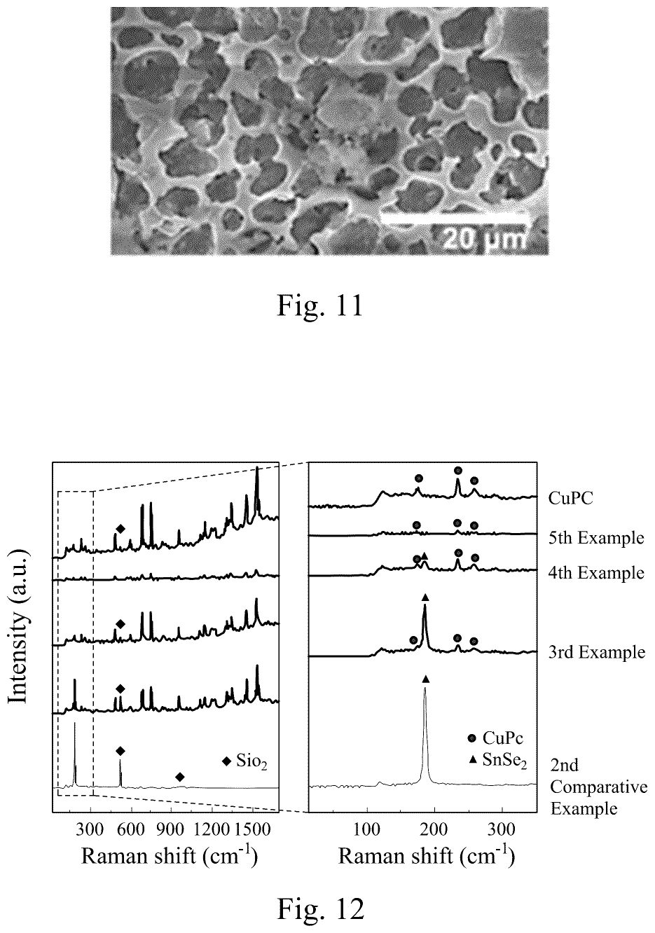

Referring to FIG. 11 and FIG. 12, FIG. 11 is a scanning electron microscope image of the gas sensing chip of the 3rd example, and FIG. 12 is a Raman spectrum of the gas selectivity-enhancing compound layer and copper phthalocyanine in the gas sensing chips of the 3rd example to the 5th example and the 2nd comparative example. From FIG. 11, it can be understood that the gas selectivity-enhancing compound layer of the gas sensing chip of the 3rd example is uniformly disposed on the surface of the two-dimensional semiconductor thin film. From FIG. 12, it can be understood that the gas selectivity-enhancing compound layers of the 3rd example to the 5th example have the characteristic peaks of copper phthalocyanine, and the characteristic peaks in the 4th example are the most noticeable.

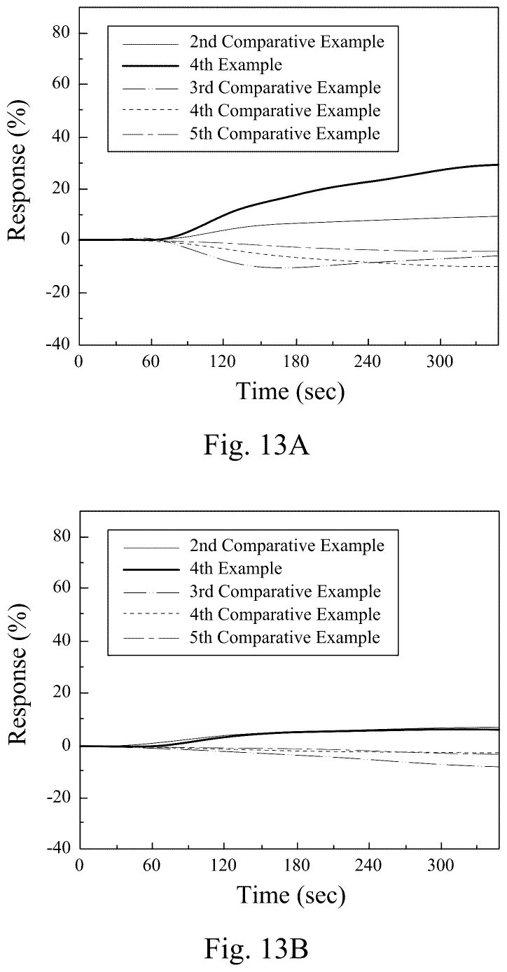

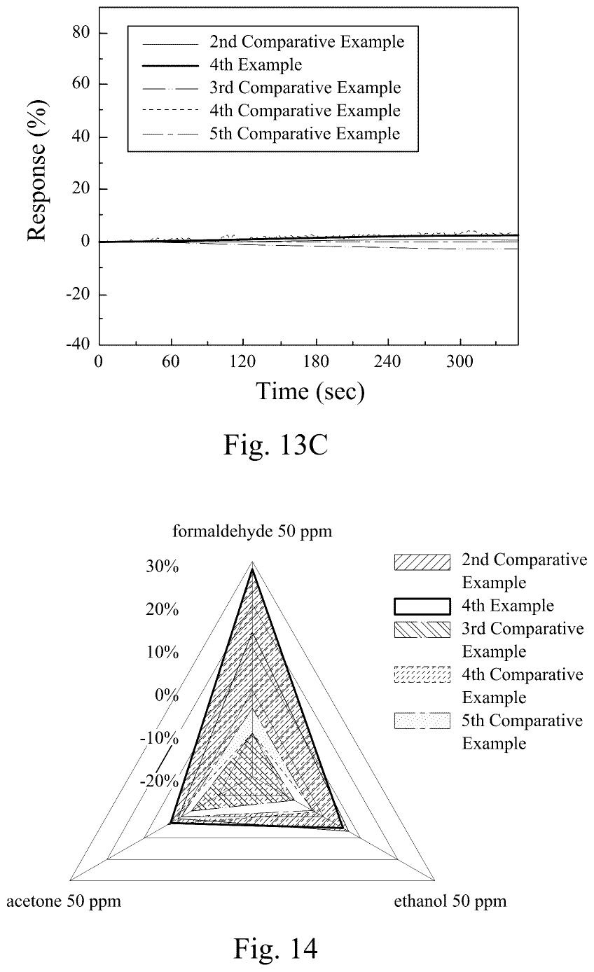

Referring to FIG. 13A to FIG. 13C, FIG. 13A is a comparison chart of the response to formaldehyde of the gas sensing chips of the 4th example and the 2nd comparative example to the 5th comparative example, FIG. 13B is a comparison chart of the response to ethanol of the gas sensing chips of the 4th example and the 2nd comparative example to the 5th comparative example, and FIG. 13C is a comparison chart of the response to acetone of the gas sensing chips of the 4th example and the 2nd comparative example to the 5th comparative example. From FIG. 13A and FIG. 13B, it can be understood that the gas sensing chip of the 4th example has excellent response to formaldehyde and ethanol. From FIG. 13C, it can be understood that the gas sensing chip of the 4th example has a similar response to acetone to those of the gas sensing chips of the 2nd comparative example to the 5th comparative example.

Referring to FIG. 14, FIG. 14 is a comparison chart of the response to formaldehyde, ethanol and acetone of the gas sensing chips of the 4th example and the 2nd comparative example to the 5th comparative example. From FIG. 14, it can be understood that the gas sensing chip of the 2nd comparative example responds to formaldehyde, ethanol and acetone. The gas sensing chip of the 4th example includes the gas selectivity-enhancing compound layer with copper phthalocyanine, the responsiveness to formaldehyde of the gas sensing chip can be significantly improved, and the response to ethanol and acetone can be simultaneously maintained. Therefore, the selectivity to different gases of the gas sensing chip can be improved.

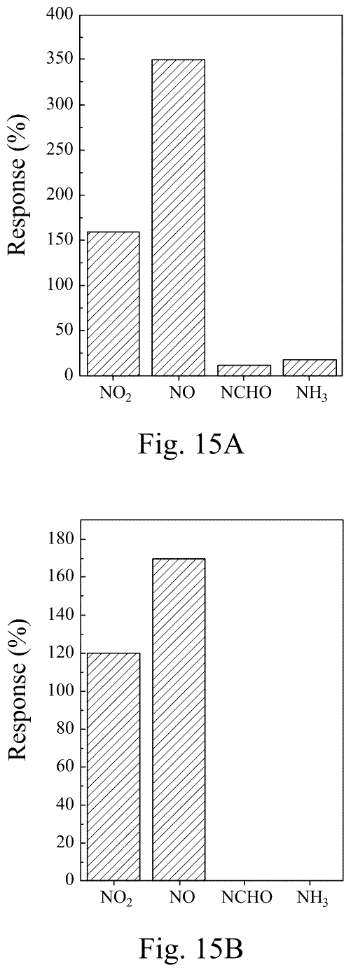

Referring to FIG. 15A and FIG. 15B, FIG. 15A is a comparison chart of the response to different gases of the gas sensing chip of the 6th comparative example, and FIG. 15B is a comparison chart of the response to different gases of the gas sensing chip of the 6th example. From FIG. 15A, it can be understood that the gas sensing chip of the 6th comparative example responds to nitrogen dioxide, nitrogen oxide, formaldehyde and ammonia, so it is difficult to distinguish between the detection results of the four gases. From FIG. 15B, it can be understood that due to the arrangement of the gas selectivity-enhancing compound layer including hexagonal boron nitride in the gas sensing chip of the 6th example, only nitrogen dioxide and nitrogen oxide can be adsorbed on the surface of the gas selectivity-enhancing compound layer among the aforementioned four gases. Therefore, the signals from formaldehyde and ammonia can be effectively reduced, and the responsiveness of the gas sensing chip to formaldehyde and ammonia can be significantly suppressed.

In summary, the gas sensing chip of the present disclosure uses the two-dimensional semiconductor as the sensing material, and has the advantages such as high sensitivity, excellent measurement reproducibility, low power consumption and resistance to temperature fluctuation and humidity fluctuation. The gas sensing chip of the present disclosure can be operated under room temperature, have low manufacturing costs, and can be manufactured on a large scale, so the application limitations of the gas sensing chip are overcome. Furthermore, the gas selectivity-enhancing compound is applied in the present disclosure, which can adsorb gases and change the resistance of the two-dimensional semiconductor by surface charge transferring. It prevents the direct contact between the two-dimensional semiconductor and external gases, which enhances the selectivity of the gas sensing chip and improves the stability and potential for application of the gas sensing chip.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A manufacturing method of a gas sensing chip, comprising:
providing a two-dimensional semiconductor; and
coating a gas selectivity-enhancing compound on a surface of the two-dimensional semiconductor;
wherein the gas selectivity-enhancing compound comprises at least one of hexagonal boron nitride, zeolitic imidazolate framework and copper phthalocyanine.

2. The manufacturing method of the gas sensing chip of claim 1, wherein the two-dimensional semiconductor comprises at least one of platinum diselenide, tin diselenide and molybdenum disulfide.

3. The manufacturing method of the gas sensing chip of claim 1, wherein the two-dimensional semiconductor is a thin film, and a thickness of the thin film is from 1 nm to 10 nm.

4. The manufacturing method of the gas sensing chip of claim 3, wherein the thin film is formed by stacking a plurality of structural layers, and a thickness of each of the plurality of structural layers is from 0.1 nm to 1.0 nm.

5. The manufacturing method of the gas sensing chip of claim 1, wherein a thickness of the gas selectivity-enhancing compound on the surface of the two-dimensional semiconductor is from 0.1 nm to 1.0 nm.

6. The manufacturing method of the gas sensing chip of claim 1, wherein the hexagonal boron nitride is coated on the surface of the two-dimensional semiconductor by the following steps:
providing a substrate, wherein the hexagonal boron nitride and a polymer are formed on a surface of the substrate;
electrically connecting the substrate to a cathode of a water electrolysis device, and applying a current to the water electrolysis device, so as to make the hexagonal boron nitride and the polymer detach from the substrate to form a hexagonal boron nitride film;
transferring the hexagonal boron nitride film to the surface of the two-dimensional semiconductor; and
removing the polymer from the hexagonal boron nitride film by a solvent.

7. The manufacturing method of the gas sensing chip of claim 6, wherein the polymer comprises at least one of poly(methyl methacrylate), polycarbonate and polypropylene carbonate.

8. The manufacturing method of the gas sensing chip of claim 1, wherein the hexagonal boron nitride is coated on the surface of the two-dimensional semiconductor by the following steps:
providing a substrate, wherein the hexagonal boron nitride and a polymer are formed on a surface of the substrate;
using a tape to detach the hexagonal boron nitride and the polymer from the substrate to form a hexagonal boron nitride film;
transferring the hexagonal boron nitride film to the surface of the two-dimensional semiconductor and removing the tape; and
removing the polymer from the hexagonal boron nitride film by a solvent.

9. The manufacturing method of the gas sensing chip of claim 8, wherein the polymer comprises at least one of poly(methyl methacrylate), polycarbonate and polypropylene carbonate.

10. The manufacturing method of the gas sensing chip of claim 1, wherein the hexagonal boron nitride is coated on the surface of the two-dimensional semiconductor by the following steps:
providing a substrate, wherein the hexagonal boron nitride and a polymer are formed on a surface of the substrate;
removing the substrate by an etching method to form a hexagonal boron nitride film, wherein the hexagonal boron nitride film comprises the hexagonal boron nitride and the polymer;
transferring the hexagonal boron nitride film to the surface of the two-dimensional semiconductor; and
removing the polymer from the hexagonal boron nitride film by a solvent.

11. The manufacturing method of the gas sensing chip of claim 10, wherein the polymer comprises at least one of poly(methyl methacrylate), polycarbonate and polypropylene carbonate.

12. The manufacturing method of the gas sensing chip of claim 1, wherein the zeolitic imidazolate framework is covered on the surface of the two-dimensional semiconductor by a coating method.

13. The manufacturing method of the gas sensing chip of claim 1, wherein the copper phthalocyanine is coated on the surface of the two-dimensional semiconductor by the following steps:
providing a copper phthalocyanine solution comprising the copper phthalocyanine and a solvent;
coating the copper phthalocyanine solution on the surface of the two-dimensional semiconductor by a drop-casting method; and
removing the solvent from the copper phthalocyanine solution.

14. The manufacturing method of the gas sensing chip of claim 13, wherein a weight ratio of the copper phthalocyanine in the copper phthalocyanine solution is from 1% to 10%.

15. A gas sensing chip, comprising:
a two-dimensional semiconductor thin film; and
a gas selectivity-enhancing compound layer disposed on a surface of the two-dimensional semiconductor thin film;
wherein a material of the gas selectivity-enhancing compound layer comprises at least one of hexagonal boron nitride, zeolitic imidazolate framework and copper phthalocyanine.

16. The gas sensing chip of claim 15, wherein a material of the two-dimensional semiconductor thin film comprises at least one of platinum diselenide, tin diselenide and molybdenum disulfide.

17. The gas sensing chip of claim 15, wherein a thickness of the two-dimensional semiconductor thin film is from 1 nm to 10 nm.

18. The gas sensing chip of claim 15, wherein the two-dimensional semiconductor thin film is formed by stacking a plurality of structural layers, and a thickness of each of the plurality of structural layers is from 0.1 nm to 1.0 nm.

19. The gas sensing chip of claim 15, wherein a thickness of the gas selectivity-enhancing compound layer is from 0.1 nm to 1.0 nm.

20. A gas sensing device, comprising:
a gas sensing chip of claim 15;
a sensing chamber having a compartment and an air inlet, wherein the compartment is in communication with outside through the air inlet, and the gas sensing chip is located in the compartment; and
a signal processing unit electrically connected to the gas sensing chip.
